(19) United States
(12) Patent Application Publication
(10) Pub. No.: US 2026/0251519 A1
(43) Pub. Date: Aug. 27, 2026

(54) DEF PRESSURE SENSORS INCLUDING FREEZE-PROTECTIVE SEALS

(71) Applicant: Cummins Inc., Columbus, IN (US)

(72) Inventors: Subash Krishna Selvakumar, Marktheidenfeld (DE); Pallavi Balpande, Pune (IN); Lukas Kaufmann, Tiefenthal (DE); Julian Nicolas Aljoscha Raupp, Waldbuettelbrunn (DE); Sandesh Mathpati, Pune (IN)

(21) Appl. No.: 19/462,232

(22) Filed: Jan. 28, 2026

(30) Foreign Application Priority Data
Feb. 25, 2025 (IN) 202541016350

(51) Int. Cl. G01L 19/06; F01N 3/20

(52) U.S. Cl. CPC G01L 19/06; F01N 3/2066; F01N 2610/02; F01N 2610/148

(57) ABSTRACT

A pressure sensor for a diesel exhaust dosing system includes a pressure sensor cell, a central support tube, and an elastomeric membrane surrounding at least a portion of the central support tube. The he elastomeric membrane includes a core portion surrounding and supported by the central support tube and extending intermediate a first membrane end and a second membrane end, a first annular protrusion extending outward from the core portion at a location proximate the first membrane end, a second annular protrusion extending outward from the core portion at a location proximate the second membrane end, and a plurality of ribs positioned intermediate the first annular protrusion and the second annular protrusion and extending outward from the core portion, and a plurality of air-filled expansion volumes disposed intermediate the plurality of ribs.

### CROSS-REFERENCE

The present application claims priority to and the benefit of Indian Application No. 202541016350 filed Feb. 25, 2025, and the same is hereby incorporated by reference.

### BACKGROUND

The present application relates generally to pressure sensors and more particularly, but not exclusively to, diesel exhaust fluid (DEF) pressure sensors including freeze-protective seals, as well as to related apparatuses, systems, processes, and techniques.

In order to mitigate emissions of oxides of nitrogen (NOx), diesel engines may include exhaust aftertreatment systems including selective catalytic reduction (SCR) catalysts that are supplied with diesel exhaust fluid (DEF) by a dosing system. Pressure sensors may be utilized for sensing pressure of DEF in the dosing system to provide accurate and reliable dosing of DEF. Such systems are vulnerable to freezing conditions in which DEF in the system expands and exerts unacceptable force on system components. A number of proposals have been made for mitigating undesirable effects of freezing on such systems. Existing approaches suffer from a number of disadvantages, drawbacks, problems, and shortcomings including those respecting complexity, cost, and reliability, among others. There remains a significant need for the unique apparatuses, processes, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some embodiments include unique diesel exhaust fluid pressure sensing apparatus. Some embodiments include unique diesel exhaust fluid pressure sensing systems. Some embodiments include unique diesel exhaust fluid pressure sensing processes. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example powertrain system.

FIG. 2 is a schematic diagram illustrating certain aspects of a diesel exhaust fluid (DEF) dosing system.

FIG. 3 is a side sectional view depicting certain aspects of an example pressure sensor.

FIG. 4 is a perspective view depicting certain aspects of a central support tube and a membrane of the pressure sensor of FIG. 3.

FIG. 5 is a sectional perspective view depicting certain aspects of the central support tube and the membrane of the pressure sensor of FIG. 3.

FIG. 6 a perspective view depicting certain aspects the membrane of the example pressure sensor of FIG. 3.

FIG. 7 is a top view depicting certain aspects of the central support tube and the membrane of the pressure sensor of FIG. 3.

FIG. 8 is a side view depicting certain aspects of the central support tube and the membrane of the pressure sensor of FIG. 3.

FIG. 9 is a side view depicting certain aspects of the central support tube of the pressure sensor of FIG. 3.

FIG. 10 is a perspective view depicting certain aspects of the central support tube of the pressure sensor of FIG. 3.

FIG. 11 is a flow diagram depicting certain aspects of an example process.

FIG. 12 is an exploded perspective view depicting certain aspects of another example pressure sensor.

FIG. 13 is a side sectional view depicting certain aspects of the example pressure sensor of FIG. 12.

FIG. 14 is a side sectional view depicting certain aspects of the example pressure sensor of FIG. 12.

FIG. 15 is a perspective partially sectional view depicting certain aspects of the example pressure sensor of FIG. 12.

### DETAILED DESCRIPTION OF EXAMPLE EMBODIMENTS

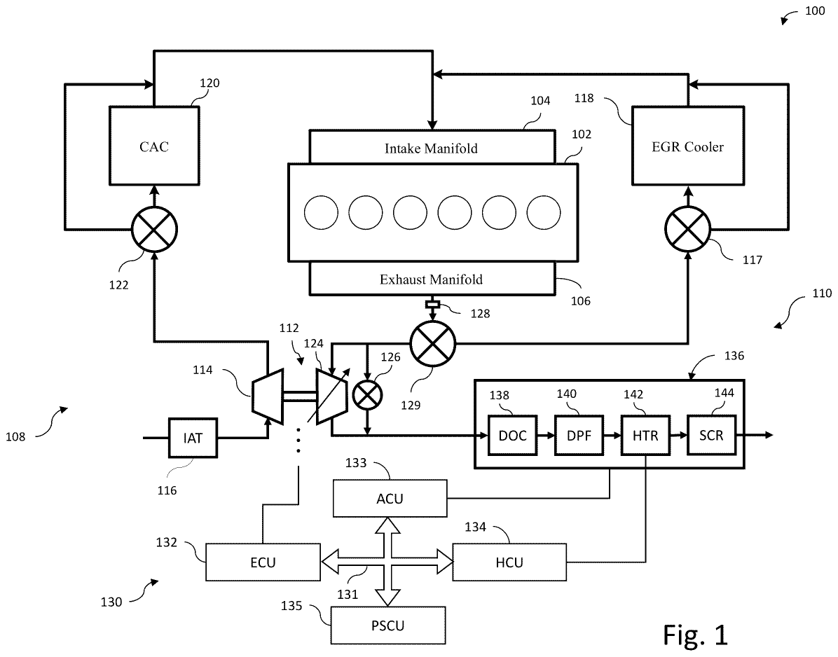

With reference to FIG. 1, there is illustrated an example powertrain system 100 (also referred to herein as system 100) including a prime mover in the form of an internal combustion engine (ICE) 102. System 100 may be provide in a number of forms including, for example, in the form of a vehicle or vehicle powertrain system (e.g., an on-highway vehicle or vehicle powertrain system or an off-highway vehicle or vehicle powertrain system), a work machine or work machine powertrain system, a genset or genset powertrain system, or a hydraulic fracturing rig or hydraulic fracturing rig powertrain system, to name several non-limiting examples. In shall be appreciated that system 100 may include a number of other components as will occur to one of skill in the art with the benefit and insight of the present disclosure. Furthermore, while engine 102 is provided as a prime mover of system 100 in the illustrated embodiment, other embodiments may comprise other types of prime movers, for example, battery electric drive systems, hybrid ICE-battery electric systems, a fuel cell electric drive system, or prime mover systems comprising combinations of the foregoing and/or other types of prime mover system as will occur to one of skill in the art with the benefit and insight of the present disclosure.

System 100 includes an intake system 108 and an exhaust system 110. The engine 102 is in fluid communication with the intake system 108 through which charge air enters an intake manifold 104 and is also in fluid communication with the exhaust system 110, through which exhaust gas resulting from combustion exits by way of an exhaust manifold 106. The engine 102 includes a number of cylinders (e.g., cylinders 1 through 6) forming combustion chambers in which a charge flow mixture of fuel and air is combusted. For example, the energy released by combustion powers the engine 102 via pistons in the cylinders connected to a crankshaft. Intake valves control the admission of charge air into the cylinders, and exhaust valves control the outflow of exhaust gas through exhaust manifold 106 and ultimately to the atmosphere. It shall be appreciated that the exhaust manifold 106 may be a single manifold or multiple exhaust manifolds.

The turbocharger 112 includes a compressor 114 configured to receive filtered intake air via an intake air throttle (IAT) 116 of the intake system 108 and operable to compress ambient air before the ambient air enters the intake manifold 104 of the engine 102 at increased pressure. The air from the compressor 114 is pumped through the intake system 108, to the intake manifold 104, and into the cylinders of the engine 102, typically producing torque on the crankshaft. IAT 116 is flow coupled with a charge air cooler (CAC) 120 which is operable to cool the charge flow provided to the intake manifold 104. The intake system 108 also includes a CAC bypass valve 122 which can be opened to route a portion or all of the charge flow to bypass the CAC 120. Adjusting the bypass position of the CAC bypass valve 122 increasingly raises the temperature of the gas returned to the intake manifold 104.

It is contemplated that in system 100, the turbocharger 112 may be a variable geometry turbocharger (VGT) or a fixed geometry turbocharger. A variable geometry turbine allows significant flexibility over the pressure ratio across the turbine. In diesel engines, for example, this flexibility can be used for improving low speed torque characteristics, reducing turbocharger lag and driving exhaust gas recirculation flow. In an example embodiment, the VGT 124 can be adjusted to increase engine load and thereby configured to increase exhaust gas temperature. System 100 also includes a turbine bypass valve 126 to bypass the turbocharger 112. Since cooler ambient air is introduced at the turbocharger 112, opening the turbine bypass valve 126 allows for the turbocharger 112 to be bypassed and maintain a higher intake air temperature at the intake manifold 104.

The exhaust system 110 includes an exhaust gas temperature sensor 128 to sense the temperature of the gas exiting the exhaust manifold 106. The exhaust system 110 includes an exhaust gas recirculation (EGR) valve 129 which recirculates a portion of exhaust gas from the exhaust manifold 106 back to the intake manifold 104. The exhaust system 110 includes an EGR cooler (EGR-C) 118 which cools the gas exiting the exhaust manifold 106 before the gas returns to the intake manifold 104. The exhaust system 110 may also include an EGR-C bypass valve 117 which can be opened to route a portion or all of the recirculated exhaust gas from the exhaust manifold 106 to bypass the EGR-C 118. By increasing the amount of gas that bypasses the EGR-C 118, the temperature of the gas returning to the intake manifold 104 is increased. It shall be appreciated that the intake system 108 and/or the exhaust system 110 may further include various components not shown, such as additional coolers, valves, bypasses, intake throttle valves, exhaust throttle valves, and/or compressor bypass valves, for example.

System 100 includes an exhaust aftertreatment (AT) system 136 which includes a diesel oxidation catalyst (DOC) 138, a diesel particulate filter (DPF) 140, aftertreatment (AT) heater 142, and a selective catalytic reduction (SCR) 144. In the example embodiment, the AT heater 142 is optionally included in the AT system 136 to increase the temperature of the exhaust gas provided to the SCR 144 within the AT system 136. It should be noted that AT heater 142 can include one or more electric heaters distributed at various locations at, on, within, or upstream of SCR 144 or other catalyst elements of AT system 136.

System 100 includes an electronic control system (ECS) 130. In the illustrated embodiment, ECS 130 includes a plurality of electronic control units (ECU) including an engine control module (ECM) 132, an aftertreatment control unit (ACU) 133, a heater control unit (HCU) 134, and power system control unit (PSCU) 135 which are operatively communicatively coupled with one another via one or more datalinks 131 which may comprise one or more controller area networks (CAN) and/or other types of datalinks. System 100 may include a number of other control units and controller as will occur to one of skill in the art with the benefit and insight of the present disclosure.

ECM 132 is operatively communicatively coupled with and configured and operable to control operation of and/or receive inputs from actuators, controllers, devices, sensors, and/or other components of system 100 including, for example, a number of the aforementioned features of system 100.

HCU 134 is operatively coupled with and configured and operable to control operation of and/or receive inputs from AT heater 142. It shall be appreciated that various communications hardware and protocols may be utilized to implement, such as one or more controller area networks (CAN) or other communications components.

PSCU 135 operatively communicatively coupled with and configured and operable to control operation of and/or receive inputs from an electrical power system of system 100 such as, for example, a motor generator system, a battery system, or other types of electrical power systems.

ECM 132, ACU 133, HCU 134, PSCU 135, and other components of ECS 130 may include one or more programmable controllers of a solid-state, integrated circuit type, and one or more non-transitory memory media configured to store instructions executable by the one or more microcontrollers. For purposes of the present application the term controller shall be understood to also encompass microcontrollers, microprocessors, application specific integrated circuits (ASIC), other types of integrated circuit processors and combinations thereof.

ECM 132, ACU 133, HCU 134, PSCU 135, and other components of ECS 130 may be implemented in any of a number of ways that combine or distribute the control function across one or more control units in various manners. The ECS 130 may execute operating logic that defines various control, management, and/or regulation functions. This operating logic may be in the form of dedicated hardware, such as a hardwired state machine, analog calculating machine, programming instructions, and/or a different form as would occur to those skilled in the art. The ECS 130 may be provided as a single component or a collection of operatively coupled components; and may be comprised of digital circuitry, analog circuitry, or a hybrid combination of both of these types. When of a multi-component form, the ECS 130 may have one or more components remotely located relative to the others in a distributed arrangement. The ECS 130 can include multiple processing units arranged to operate independently, in a pipeline processing arrangement, in a parallel processing arrangement, or the like. It shall be further appreciated that the ECS 130 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

ECM 132, ACU 133, HCU 134, PSCU 135, and other components of ECS 130 may include one or more non-transitory memory devices configured to store instructions in memory which are readable and executable by a controller to control operation of engine 102 as described herein. Certain control operations described herein include operations to determine one or more parameters. ECM 132, ACU 133, HCU 134, PSCU 135, and other components of ECS 130 may be configured to determine and may perform acts of determining in a number of manners, for example, by calculating or computing a value, obtaining a value from a lookup table or using a lookup operation, receiving values from a datalink or network communication, receiving an electronic signal (e.g., a voltage, frequency, current, or pulse-width modulation (PWM) signal) indicative of the value, receiving a parameter indicative of the value, reading the value from a memory location on a computer-readable medium, receiving the value as a run-time parameter, and/or by receiving a value by which the interpreted parameter can be calculated, and/or by referencing a default value that is interpreted to be the parameter value.

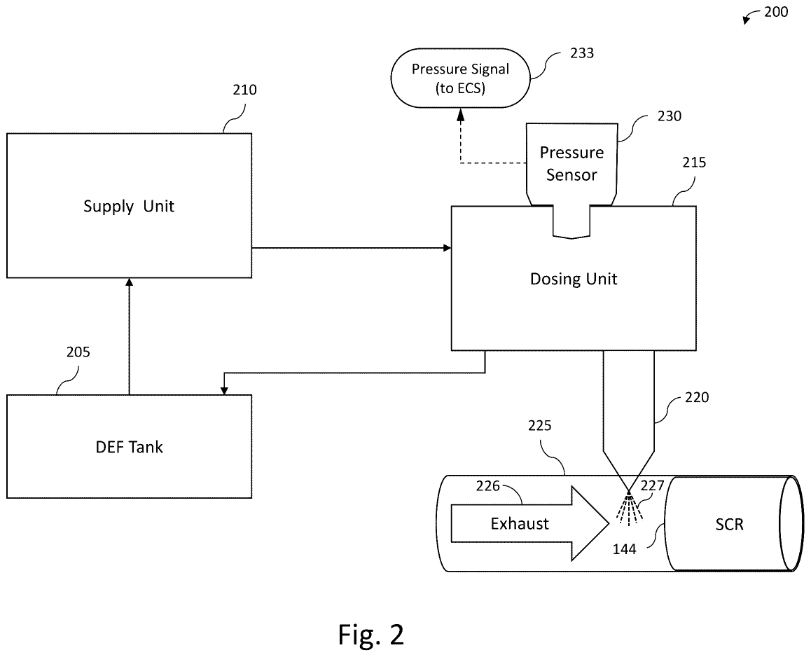

With reference to FIG. 2, there are illustrated certain aspects of an example diesel exhaust fluid (DEF) dosing system 200 (also referred to herein as system 200). It shall be appreciated that system 200 may be configured and provided as one example implementation of certain aspects of AT system 136. System 200 includes DEF tank 205, supply unit 210, dosing unit 215, injector 220, and pressure sensor 230. DEF tank 205 is configured to store supply of diesel exhaust fluid, typically a urea solution. Supply unit 210 configured to pump diesel exhaust fluid from DEF tank 205 to dosing unit 215. Dosing unit 215 is configured to meter and dose a variable amount of diesel exhaust fluid into exhaust conduit 225 via injector 220. SCR catalyst 144 is provided in exhaust conduit 225 and receives a flow of exhaust 226 in which a dosed quantity of diesel exhaust fluid 227 is entrained. Pressure sensor 230 is operatively coupled with dosing unit 215 and is configured to sense a pressure of diesel exhaust fluid within dosing unit 215 and provide a pressure signal 233 indicative of the sensed pressure to an electronic control system, such as ECS 130.

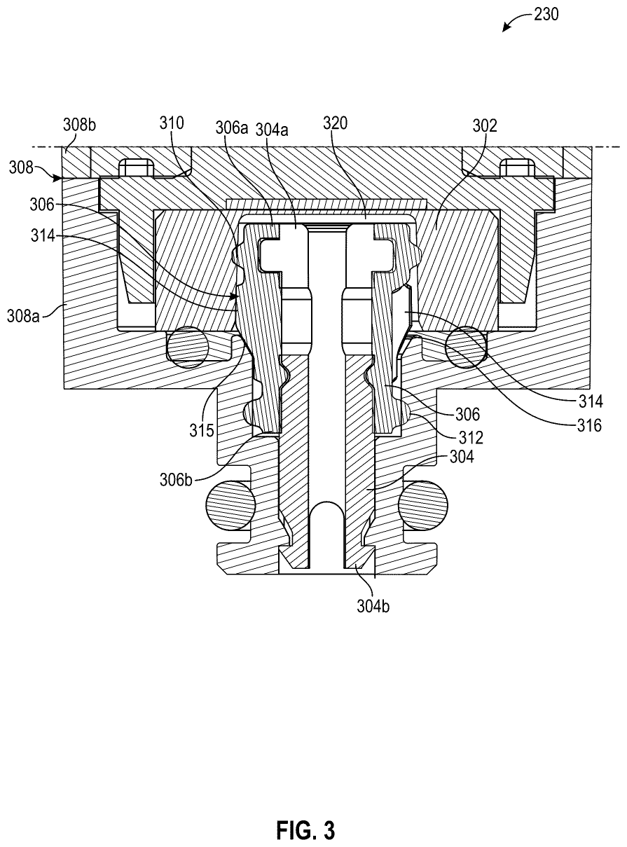

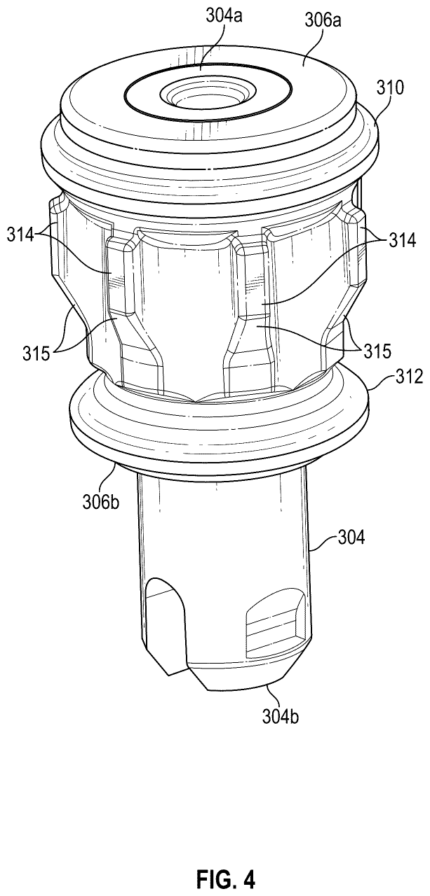

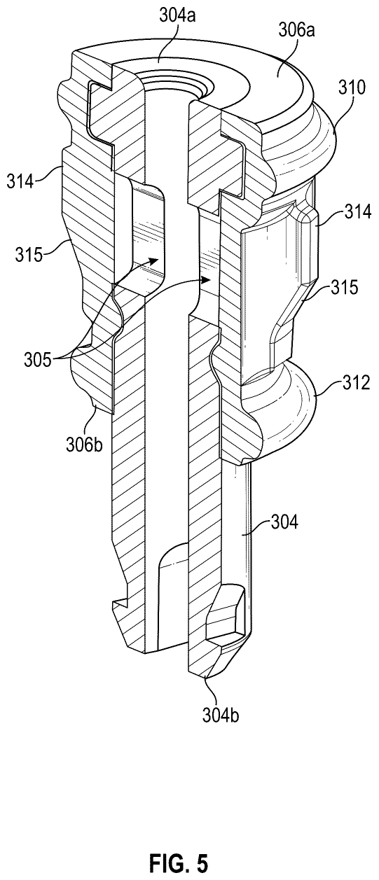

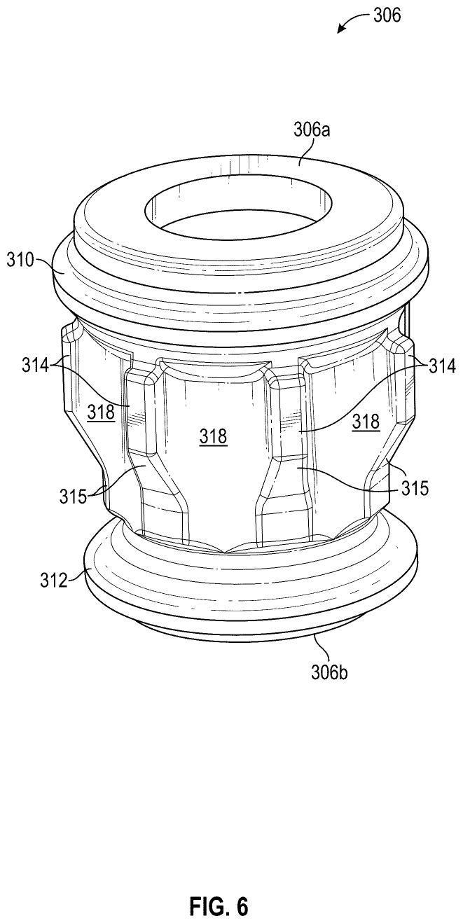

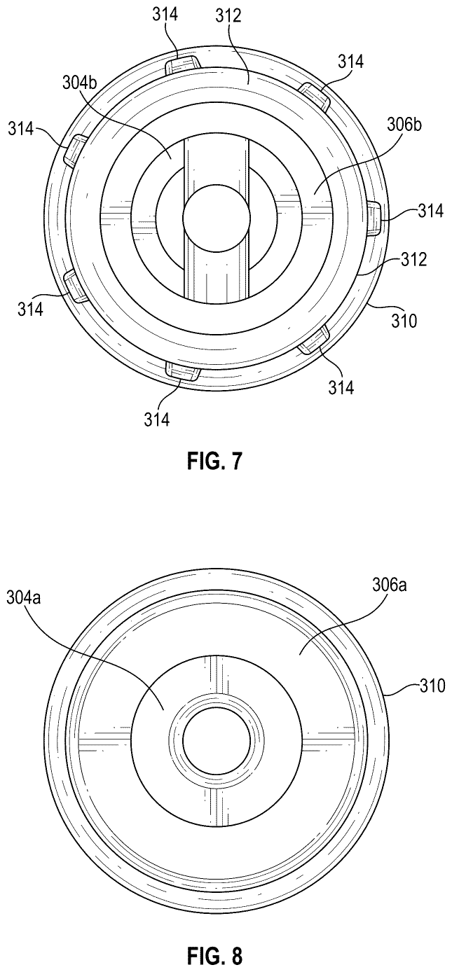

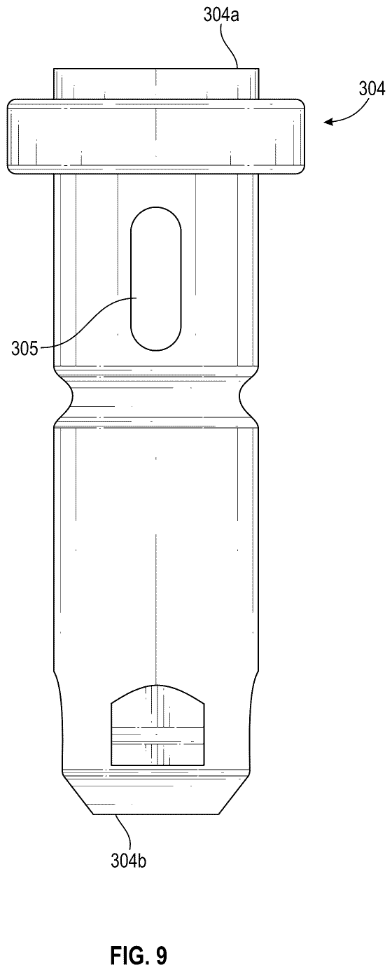

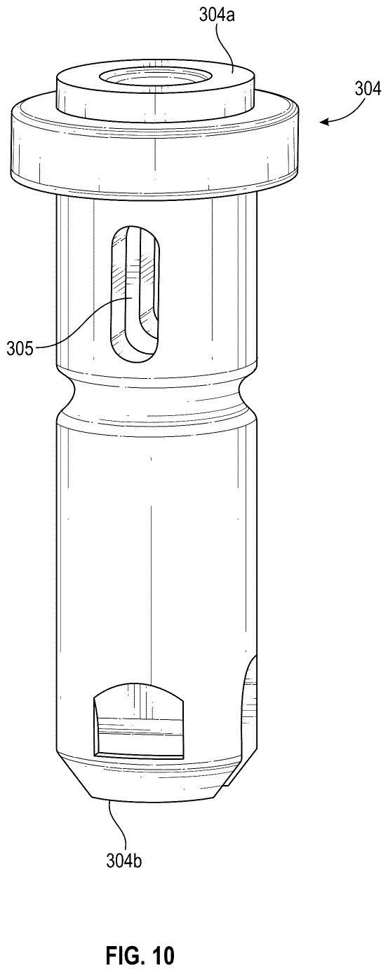

With reference to FIGS. 3-10, there are illustrated several views depicting certain aspects of an example embodiment of pressure sensor 230 and components thereof. It shall be appreciated that the illustrated embodiment of pressure sensor 230 is one example of an apparatus for sensing pressure of diesel exhaust fluid in a dosing system according to the present disclosure and that various other embodiments of pressure sensors according to the pressure disclosure including additional and/or alternative arrangements, configurations, dimensions, elements, features, geometries, and other structures are also contemplated as will occur to one of skill in the art with the benefit and insight of the present disclosure.

Pressure sensor includes a pressure sensor cell 302, a central support tube 304, an elastomeric membrane 306, and a housing 308 surrounding the pressure sensor cell 302, the support tube 304 and the elastomeric membrane 306. In the illustrated embodiment, the housing 308 comprises a lower portion 308b which is configured to be operatively coupled with a dosing unit such as dosing unit 215 illustrated and described in connection with FIG. 2. The dosing unit may, in turn, be operatively coupled with an injector configured to provide diesel exhaust fluid to a selective catalytic reduction (SCR) catalyst, for example, as illustrated and described in connection with FIG. 2. Other housing configurations are also contemplated as will occur to one of skill in the art with the benefit and insight of the present disclosure.

In the illustrated embodiment, the pressure sensor cell 302 comprises a ceramic pressure sensor cell. In other embodiments, the pressure sensor cell 302 may comprise other types of pressure sensor cell 302s as will occur to one of skill in the art with the benefit and insight of the present disclosure.

The central support tube 304 extends between a first tube end 304a and a second tube end 304b and includes one or more pressure relief openings 305 positioned intermediate the first tube end 304a and the second tube end 304b.

An elastomeric membrane 306 surrounds at least a portion of the central support tube 304. The elastomeric membrane 306 extends intermediate a first membrane end 306a and a second membrane end 306b and comprises a core portion 316 surrounding and supported by the central support tube 304. A first annular protrusion 310 of the elastomeric membrane 306 extends outward from the core portion 316 at a location proximate the first membrane end 306a. A second annular protrusion 312 of the elastomeric membrane 306 extends outward from the core portion 316 at a location proximate the second membrane end 306b. A plurality of ribs 314 are positioned intermediate the first annular protrusion 310 and the second annular protrusion 312 and extend outward from the core portion 316.

In some embodiments, the elastomeric membrane 306 comprises ethylene propylene diene monomer (EPDM). In some embodiments, the elastomeric membrane 306 comprises hydrogenated nitrile butadiene rubber (HNBR). In some embodiments, elastomeric membrane 306 comprises other elastomeric material such as other types of rubbers, polymers, monomers, or other elastomeric material as will occur to one of skill in the art with the benefit and insight of the present disclosure.

A plurality of air-filled expansion volumes 318 are disposed intermediate the plurality of ribs 314. A first portion of the plurality of ribs 314 contacts a surface of the pressure sensor cell 302 to delimit at least a portion of the plurality of air-filled expansion volumes 318. A second portion of the plurality of ribs 314 contacts a surface of the housing 308 to delimit at least a second portion of the plurality of air-filled expansion volumes 318. The second portion of the plurality of ribs 314 comprises a tapered sections 315 sloping inward slope toward the core portion 316.

The first annular protrusion 310 of the elastomeric membrane 306 contacts the pressure sensor cell 302 to provide a seal between the plurality of air-filled expansion volumes 318 and a diesel exhaust fluid chamber 320 of the pressure sensor cell 302. The second annular protrusion 312 contacts the housing 308 to provide a seal between the plurality of air-filled expansion volumes 318 and an exterior of the housing 308.

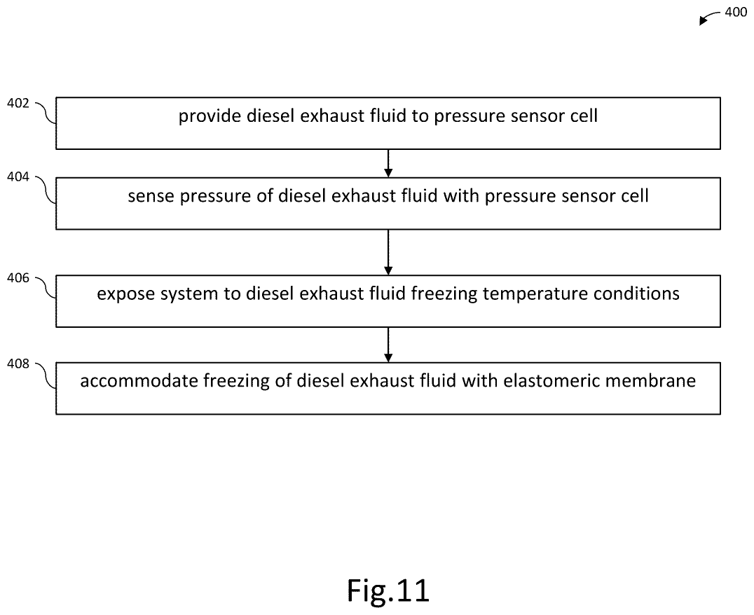

Pressure sensor 230 and other pressure sensors according to the present disclosure may be utilized in one or more processes for sensing pressure of diesel exhaust fluid in a dosing system. FIG. 11 illustrates one example process 400 which includes operation 402, operation 404, operation 406, operation 408. Operation 402 comprises providing diesel exhaust fluid to a pressure sensor cell 302 via central support tube 304 extending between a first tube end 304a and a second tube end 304b and including one or more pressure relief openings 305 positioned intermediate the first tube end 304a and the second tube end 304b. Operation 404 comprises sensing pressure of the diesel exhaust fluid with the pressure sensor cell 302. Operation 406 comprises exposing the dosing system to temperature conditions sufficient to freeze at least a portion of the diesel exhaust fluid. Operation 408 comprises accommodating freezing of the diesel exhaust fluid with an elastomeric membrane 306 surrounding at least a portion of the central support tube 304 containing freezing diesel exhaust fluid. In response to expansion of freezing diesel exhaust fluid in the central support tube 304 the core portion 316 may experience elastic deformation in regions exposed to the pressure relief openings 305. The plurality of air-filled expansion volumes 318 may decrease in volume in response to the deformation. Operation 408 may further comprise maintaining a seal between the plurality of air-filled expansion volumes 318 and a diesel exhaust fluid chamber 320 by the first annular protrusion 310 contacting the pressure sensor cell 302. Operation 408 may further comprise providing a seal between the plurality of air-filled expansion volumes 318 and an exterior of the housing 308 by the second annular protrusion 312 contacting the housing 308.

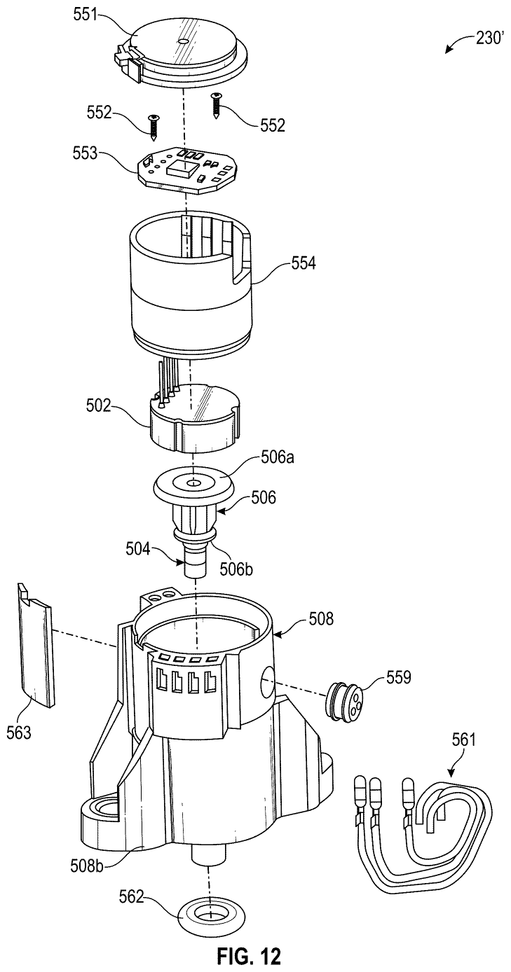

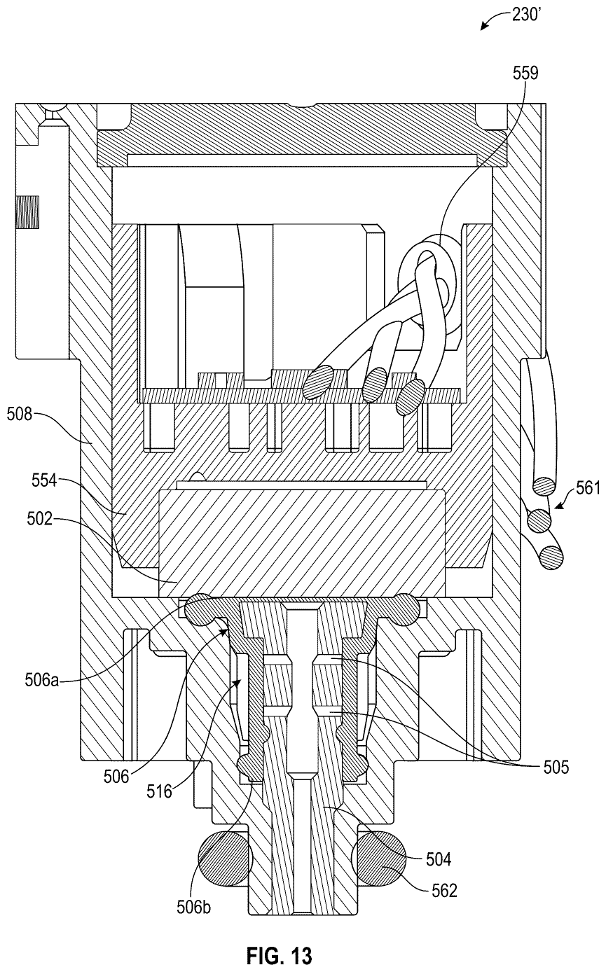

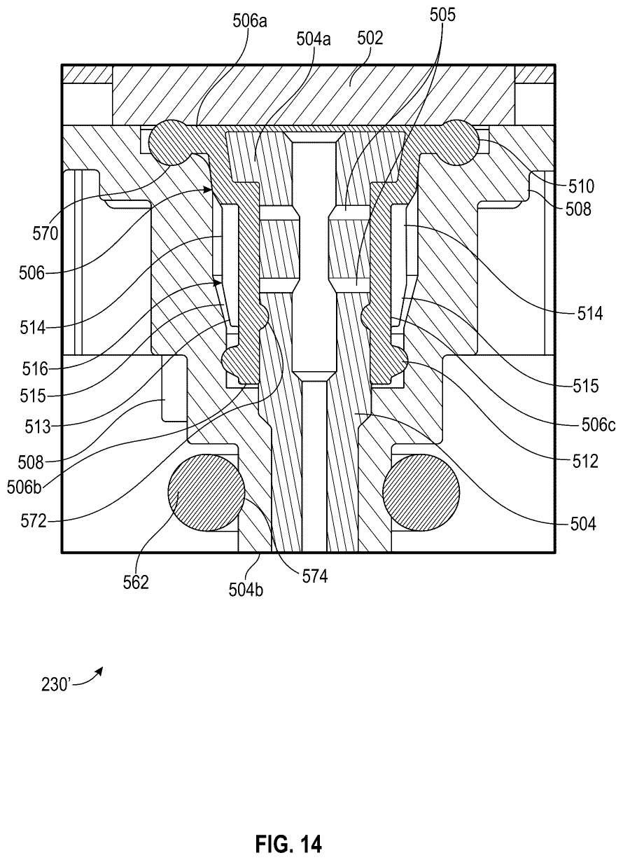

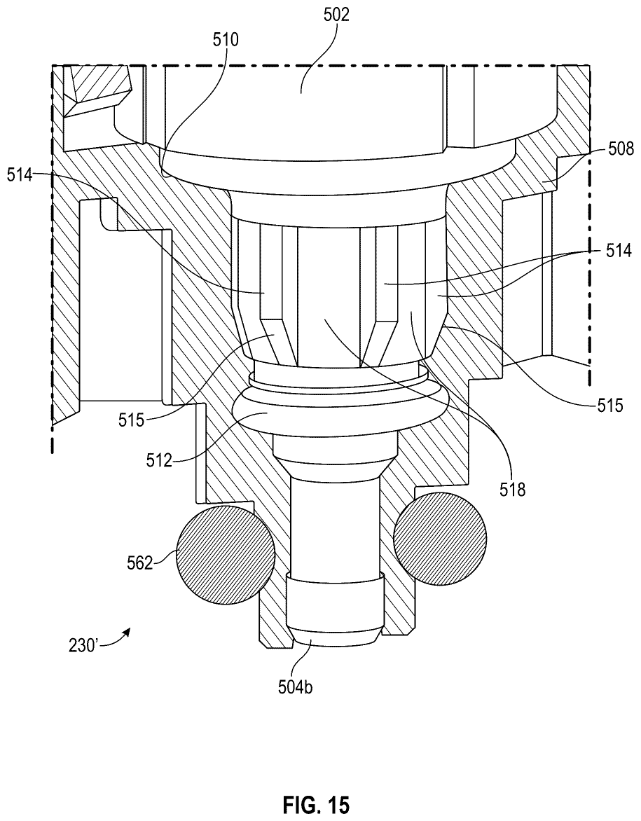

With reference to FIGS. 12-15, there are illustrated several views depicting certain aspects of another example embodiment of pressure sensor 230 referred to herein as pressure sensor 230′ and components thereof. It shall be appreciated that pressure sensor 230′ is one example of an apparatus for sensing pressure of diesel exhaust fluid in a dosing system according to the present disclosure and that various other embodiments of pressure sensors according to the pressure disclosure including additional and/or alternative arrangements, configurations, dimensions, elements, features, geometries, and other structures are also contemplated as will occur to one of skill in the art with the benefit and insight of the present disclosure.

Pressure sensor includes a pressure sensor cell 502, a central support tube 504, an elastomeric membrane 506, and a housing 508 surrounding the pressure sensor cell 502, the support tube 504 and the elastomeric membrane 506. In the illustrated embodiment, the housing 508 comprises a lower portion an upper portion 508b which is configured to be operatively coupled with a dosing unit such as dosing unit 215 illustrated and described in connection with FIG. 2. The dosing unit may, in turn, be operatively coupled with an injector configured to provide diesel exhaust fluid to a selective catalytic reduction (SCR) catalyst, for example, as illustrated and described in connection with FIG. 2. Other housing configurations are also contemplated as will occur to one of skill in the art with the benefit and insight of the present disclosure.

The housing 508 receives the pressure sensor cell 502, a central support tube 504, an elastomeric membrane 506 in a central receiving chamber which also receives a printed circuit board (PCB) holder 554. The PCB holder 554 may be laser welded to the housing 508 at one or more locations about portions of its periphery that oppose and interface with the housing 508. The PCB holder 554 receives a printed circuit board (PCB) 553 which is mounted and retained in holder by screws 551. A cover 551 is configured to mate with and cover the receiving chamber of housing 508 and also to mate with a sleeve 563 which is received by a slot formed in the housing 508 and adjustable or manipulatable to engage or disengage with cover 551 during installation or removal thereof. An O-ring 562 surrounds an exterior surface of the housing 508 proximate a protrusion extending from its lower portion 508b. The O-ring 562 is configured and operable to form a seal between the protrusion of housing 508 and a dosing unit, such as dosing unit 215, into which the protrusion is inserted. In the illustrated example, the O-ring 562 preferably interfaces with a mating recess 575 provided in an opposing surface of the protrusion of the housing 508 to aid in forming a seal therebetween.

A wiring gromet 559 is configured to mate with and cover a wiring access hole formed in housing 508. One or more wires 561 are introduced through respective holes formed in wiring gromet 559 and include terminal ends which are operatively coupled with corresponding contacts of the PCB 553. PCB 553, in turn, is operatively coupled with electrical leads of pressure sensor cell 502 and electrical communication between pressure sensor cell 502 and one or more external communication or control components may thereby established.

In the illustrated embodiment, the pressure sensor cell 502 comprises a ceramic pressure sensor cell. In other embodiments, the pressure sensor cell 502 may comprise other types of pressure sensor cells as will occur to one of skill in the art with the benefit and insight of the present disclosure. In the illustrated example pressure sensor cell 502 is configured and provided in a flat puck-like or disc-like form, it being appreciated that other embodiments contemplate other forms of pressure sensors as will occur to one of skill in the art with the benefit and insight of the present disclosure.

The central support tube 504 extends between a first tube end 504a and a second tube end 504b and includes one or more pressure relief openings 505 positioned intermediate the first tube end 504a and the second tube end 504b.

An elastomeric membrane 506 surrounds at least a portion of the central support tube 504. The elastomeric membrane 506 extends intermediate a first membrane end 506a and a second membrane end 506b and comprises a core portion 516 surrounding and supported by the central support tube 504. A first annular protrusion 510 of the elastomeric membrane 506 extends outward from the core portion 516 at a location proximate the first membrane end 506a. A second annular protrusion 512 of the elastomeric membrane 506 extends outward from the core portion 516 at a location proximate the second membrane end 506b. A plurality of ribs 514 are positioned intermediate the first annular protrusion 510 and the second annular protrusion 512 and extend outward from the core portion 516.

In some embodiments, the elastomeric membrane 506 comprises ethylene propylene diene monomer (EPDM). In some embodiments, the elastomeric membrane 506 comprises hydrogenated nitrile butadiene rubber (HNBR). In some embodiments, elastomeric membrane 506 comprises other elastomeric material such as other types of rubbers, polymers, monomers, or other elastomeric material as will occur to one of skill in the art with the benefit and insight of the present disclosure.

A plurality of air-filled expansion volumes 518 are disposed intermediate the plurality of ribs 514. A first portion of the plurality of ribs 514 contacts a surface of the pressure sensor cell 502 to delimit at least a portion of the plurality of air-filled expansion volumes 518. A second portion of the plurality of ribs 514 contacts a surface of the housing 508 to delimit at least a second portion of the plurality of air-filled expansion volumes 518. The second portion of the plurality of ribs 514 comprises a tapered sections 515 sloping inward slope toward the core portion 516.

The first annular protrusion 510 of the elastomeric membrane 506 contacts the pressure sensor cell 502 to provide a seal between the plurality of air-filled expansion volumes 518 and a diesel exhaust fluid chamber 520 of the pressure sensor cell 502. In the illustrated example, the first annular protrusion 510 preferably interfaces with a mating recess 570 provided in an opposing surface of housing 508 to aid in forming a seal between the elastomeric membrane 506 and the housing 508. Such sealing contributes to sealing of the plurality of air-filled expansion volumes 518 from the external environment.

The second annular protrusion 512 contacts and is sandwiched between a lower surface of pressure sensor cell 502 and housing 508 to provide a seal between the plurality of air-filled expansion volumes 518 and an upper exterior of the housing 508 proximate the region in which pressure sensor cell 502 is provided. In the illustrated example, the second annular protrusion 512 preferably interfaces with a mating recess 572 provided in an opposing surface of housing 508 to aid in forming a seal between the elastomeric membrane 506 and the housing 508. Such sealing contributes to sealing of the plurality of air-filled expansion volumes 518 from the external environment.

As shown by this detailed description, the present disclosure contemplates multiple and various embodiments, including, without limitation, the following example embodiments.

Example embodiment number 1 is an apparatus for sensing pressure of diesel exhaust fluid in a dosing system, the apparatus comprising: a pressure sensor cell; a central support tube extending between a first tube end and a second tube end and including one or more pressure relief openings positioned intermediate the first tube end and the second tube end; an elastomeric membrane surrounding at least a portion of the central support tube, the elastomeric membrane comprising a core portion surrounding and supported by the central support tube and extending intermediate a first membrane end and a second membrane end, a first annular protrusion extending outward from the core portion at a location proximate the first membrane end, a second annular protrusion extending outward from the core portion at a location proximate the second membrane end, and a plurality of ribs positioned intermediate the first annular protrusion and the second annular protrusion and extending outward from the core portion, and a plurality of air-filled expansion volumes disposed intermediate the plurality of ribs; and a housing surrounding the pressure sensor cell, the support tube and the elastomeric membrane.

Example embodiment number 2 includes the features of example embodiment number 1, wherein a first portion of the plurality of ribs contacts a surface of the pressure sensor cell to delimit at least a portion of the plurality of air-filled expansion volumes.

Example embodiment number 3 includes the features of example embodiment number 2, wherein a second portion of the plurality of ribs contacts a surface of the housing to delimit at least a second portion of the plurality of air-filled expansion volumes.

Example embodiment number 4 includes the features of example embodiment number 3, wherein the second portion of the plurality of ribs comprises a tapered section sloping inward slope toward the core portion.

Example embodiment number 5 includes the features of example embodiment number 1, wherein the first annular protrusion contacts the pressure sensor cell to provide a seal between the plurality of air-filled expansion volumes and a diesel exhaust fluid chamber of the pressure sensor cell.

Example embodiment number 6 includes the features of example embodiment number 1, wherein the second annular protrusion contacts the housing to provide a seal between the plurality of air-filled expansion volumes and an exterior of the housing.

Example embodiment number 7 includes the features of example embodiment number 1, wherein the elastomeric membrane comprises one of ethylene propylene diene monomer (EPDM) and hydrogenated nitrile butadiene rubber (HNBR).

Example embodiment number 8 includes the features of example embodiment number 1, wherein the pressure sensor cell comprises a ceramic pressure sensor cell.

Example embodiment number 9 includes the features of example embodiment number 1, wherein the housing is operatively coupled with a dosing unit.

Example embodiment number 10 includes the features of example embodiment number 9, wherein the dosing unit is operatively coupled with an injector configured to provide diesel exhaust fluid to a selective catalytic reduction (SCR) catalyst.

Example embodiment number 11 is a process for operating a pressure sensor configured to sense pressure of diesel exhaust fluid in a dosing system, the process comprising: providing diesel exhaust fluid to a pressure sensor cell via a central support tube extending between a first tube end and a second tube end and including one or more pressure relief openings positioned intermediate the first tube end and the second tube end; sensing pressure of the diesel exhaust fluid with the pressure sensor cell; exposing the dosing system to temperature conditions sufficient to freeze at least a portion of the diesel exhaust fluid; and accommodating freezing of the diesel exhaust fluid with an elastomeric membrane surrounding at least a portion of the central support tube containing freezing diesel exhaust fluid, the elastomeric membrane comprising a core portion surrounding and supported by the central support tube and extending intermediate a first membrane end and a second membrane end, a first annular protrusion extending outward from the core portion at a location proximate the first membrane end, a second annular protrusion extending outward from the core portion at a location proximate the second membrane end, and a plurality of ribs positioned intermediate the first annular protrusion and the second annular protrusion and extending outward from the core portion, and a plurality of air-filled expansion volumes disposed intermediate the plurality of ribs, the plurality of air-filled expansion volumes decreasing in volume in response to deformation of the core portion in one or more regions adjacent the one or more pressure relief openings in response to expansion of the freezing diesel exhaust fluid, wherein the pressure sensor cell, the support tube and the elastomeric membrane are surrounded by a housing.

Example embodiment number 12 includes the features of example embodiment number 11, wherein a first portion of the plurality of ribs contacts a surface of the pressure sensor cell to delimit at least a portion of the plurality of air-filled expansion volumes.

Example embodiment number 13 includes the features of example embodiment number 12, wherein a second portion of the plurality of ribs contacts a surface of the housing to delimit at least a second portion of the plurality of air-filled expansion volumes.

Example embodiment number 14 includes the features of example embodiment number 13, wherein the second portion of the plurality of ribs comprises a tapered section sloping inward slope toward the core portion.

Example embodiment number 15 includes the features of example embodiment number 11, comprising providing a seal between the plurality of air-filled expansion volumes and a diesel exhaust fluid chamber by the first annular protrusion contacting the pressure sensor cell.

Example embodiment number 16 includes the features of example embodiment number 11, comprising providing a seal between the plurality of air-filled expansion volumes and an exterior of the housing by the second annular protrusion contacting the housing.

Example embodiment number 17 includes the features of example embodiment number 11, wherein the elastomeric membrane comprises one of ethylene propylene diene monomer (EPDM) and hydrogenated nitrile butadiene rubber (HNBR).

Example embodiment number 18 includes the features of example embodiment number 11, wherein the pressure sensor cell comprises a ceramic pressure sensor cell.

Example embodiment number includes the features of example embodiment number 11, comprising operatively coupling the housing with a dosing unit.

Example embodiment number 20 includes the features of example embodiment number 19, comprising operatively coupling the dosing unit with an injector configured to provide diesel exhaust fluid to a selective catalytic reduction (SCR) catalyst.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus for sensing pressure of diesel exhaust fluid in a dosing system, the apparatus comprising:
a pressure sensor cell;
a central support tube extending between a first tube end and a second tube end and including one or more pressure relief openings positioned intermediate the first tube end and the second tube end;
an elastomeric membrane surrounding at least a portion of the central support tube, the elastomeric membrane comprising a core portion surrounding and supported by the central support tube and extending intermediate a first membrane end and a second membrane end, a first annular protrusion extending outward from the core portion at a location proximate the first membrane end, a second annular protrusion extending outward from the core portion at a location proximate the second membrane end, and a plurality of ribs positioned intermediate the first annular protrusion and the second annular protrusion and extending outward from the core portion, and a plurality of air-filled expansion volumes disposed intermediate the plurality of ribs; and
a housing surrounding the pressure sensor cell, the support tube and the elastomeric membrane.

2. The apparatus of claim 1, wherein a first portion of the plurality of ribs contacts a surface of the pressure sensor cell to delimit at least a portion of the plurality of air-filled expansion volumes.

3. The apparatus of claim 2, wherein a second portion of the plurality of ribs contacts a surface of the housing to delimit at least a second portion of the plurality of air-filled expansion volumes.

4. The apparatus of claim 3, wherein the second portion of the plurality of ribs comprises a tapered section sloping inward slope toward the core portion.

5. The apparatus of claim 1, wherein the first annular protrusion contacts the pressure sensor cell to provide a seal between the plurality of air-filled expansion volumes and a diesel exhaust fluid chamber of the pressure sensor cell.

6. The apparatus of claim 1, wherein the second annular protrusion contacts the housing to provide a seal between the plurality of air-filled expansion volumes and an exterior of the housing.

7. The apparatus of claim 1, wherein the elastomeric membrane comprises one of ethylene propylene diene monomer (EPDM) and hydrogenated nitrile butadiene rubber (HNBR).

8. The apparatus of claim 1, wherein the pressure sensor cell comprises a ceramic pressure sensor cell.

9. The apparatus of claim 1, wherein the housing is operatively coupled with a dosing unit.

10. The apparatus of claim 9, wherein the dosing unit is operatively coupled with an injector configured to provide diesel exhaust fluid to a selective catalytic reduction (SCR) catalyst.

11. A process for operating a pressure sensor configured to sense pressure of diesel exhaust fluid in a dosing system, the process comprising:
providing diesel exhaust fluid to a pressure sensor cell via a central support tube extending between a first tube end and a second tube end and including one or more pressure relief openings positioned intermediate the first tube end and the second tube end;
sensing pressure of the diesel exhaust fluid with the pressure sensor cell;
exposing the dosing system to temperature conditions sufficient to freeze at least a portion of the diesel exhaust fluid; and
accommodating freezing of the diesel exhaust fluid with an elastomeric membrane surrounding at least a portion of the central support tube containing freezing diesel exhaust fluid, the elastomeric membrane comprising a core portion surrounding and supported by the central support tube and extending intermediate a first membrane end and a second membrane end, a first annular protrusion extending outward from the core portion at a location proximate the first membrane end, a second annular protrusion extending outward from the core portion at a location proximate the second membrane end, and a plurality of ribs positioned intermediate the first annular protrusion and the second annular protrusion and extending outward from the core portion, and a plurality of air-filled expansion volumes disposed intermediate the plurality of ribs, the plurality of air-filled expansion volumes decreasing in volume in response to deformation of the core portion in one or more regions adjacent the one or more pressure relief openings in response to expansion of the freezing diesel exhaust fluid, wherein the pressure sensor cell, the support tube and the elastomeric membrane are surrounded by a housing.

12. The process of claim 11, wherein a first portion of the plurality of ribs contacts a surface of the pressure sensor cell to delimit at least a portion of the plurality of air-filled expansion volumes.

13. The process of claim 12, wherein a second portion of the plurality of ribs contacts a surface of the housing to delimit at least a second portion of the plurality of air-filled expansion volumes.

14. The process of claim 13, wherein the second portion of the plurality of ribs comprises a tapered section sloping inward slope toward the core portion.

15. The process of claim 11, comprising providing a seal between the plurality of air-filled expansion volumes and a diesel exhaust fluid chamber by the first annular protrusion contacting the pressure sensor cell.

16. The process of claim 11, comprising providing a seal between the plurality of air-filled expansion volumes and an exterior of the housing by the second annular protrusion contacting the housing.

17. The process of claim 11, wherein the elastomeric membrane comprises one of ethylene propylene diene monomer (EPDM) and hydrogenated nitrile butadiene rubber (HNBR).

18. The process of claim 11, wherein the pressure sensor cell comprises a ceramic pressure sensor cell.

19. The process of claim 11, comprising operatively coupling the housing with a dosing unit.

20. The process of claim 19, comprising operatively coupling the dosing unit with an injector configured to provide diesel exhaust fluid to a selective catalytic reduction (SCR) catalyst.
